(19) United States
(12) Patent Application Publication
(10) Pub. No.: US 2014/0253090 A1
(43) Pub. Date: Sep. 11, 2014

(54) CONFIGURABLE INTEGRATED CIRCUIT ENABLING MULTIPLE SWITCHED MODE OR LINEAR MODE POWER CONTROL TOPOLOGIES

(71) Applicant: ATMEL CORPORATION, San Jose, CA (US)

(72) Inventors: Dilip Sangam, Saratoga, CA (US); Wai-Keung Peter Cheng, Union City, CA (US)

(73) Assignee: ATMEL CORPORATION, San Jose, CA (US)

(21) Appl. No.: 13/785,858

(22) Filed: Mar. 5, 2013

(51) Int. Cl. G05F 3/02

(52) U.S. Cl. CPC G05F 3/02
USPC 323/351

(57) ABSTRACT

An integrated circuit is operable for implementing any of multiple switched mode or linear power control topologies. The integrated circuit includes a control unit, and functional blocks each of which includes circuitry. The control unit is operable selectively to enable particular ones of the functional blocks in response to an input signal indicative of a particular one of the switched mode or linear mode power control topologies.

### FIELD OF THE DISCLOSURE

The present disclosure relates to a configurable integrated circuit that enables multiple switched mode or linear mode power control topologies.

### BACKGROUND

A switched mode power supply is an electronic power supply that incorporates a switching regulator to convert electrical power efficiently. A linear mode power supply maintains a constant output voltage or current to the load. One application for such power control is light emitting diode (LED) product designs, which can be used in order to convert energy from the input power provided to the LED devices in an efficient and reliable way. However, different power control topologies are generally applicable for different designs, and each topology uses a particular control scheme to achieve the desired power conversion and regulation. This situation tends to complicate power control in LED and other applications.

### SUMMARY

The present disclosure describes an integrated circuit operable to provide multiple switched mode and linear mode power control topologies.

For example, in one aspect, an integrated circuit is operable for implementing any of multiple switched mode or linear power control topologies. The integrated circuit includes a control unit, and functional blocks each of which includes circuitry. The control unit is operable selectively to enable particular ones of the functional blocks in response to an input signal indicative of a particular one of the switched mode or linear mode power control topologies.

Another aspect describes a method that includes receiving a user-selection signal as an input to the integrated circuit, wherein the user-selection signal is indicative of a particular one of the switched mode or linear mode power control topologies. The method also includes selectively enabling, in response to the user-selection signal, a particular group of functional blocks in the integrated circuit, each of the functional blocks comprising circuitry.

According to a further aspect, a method of implementing a switched mode or linear mode power control topology includes connecting external application-specific circuitry to one or more input/output pins of an integrated circuit that is operable for implementing any of multiple switched mode or linear mode power control topologies, and providing a user-selection signal as an input to the integrated circuit. The user-selection signal is indicative of a particular one of the switched mode or linear mode power control topologies and causes a control unit in the integrated circuit selectively to enable a particular group of functional blocks in the integrated circuit, wherein each of the functional blocks comprises circuitry.

Some implementations can achieve various advantages. For example, the integrated circuit can allow end-product system designers to use the same integrated circuit to achieve their product designs for a range of different solutions. The integrated circuit thus can help engineers design and implement various power control topologies more easily and efficiently. In some implementations, these features can help reduce the design complexity and can help reduce the cost of bringing a power control product to market.

Other aspects, features and advantages will be readily apparent from the following detailed description, the accompanying drawings, and the claims.

### BRIEF DESCRIPTION OF THE DRAWINGS

FIG. 1 illustrates an example of a configurable integrated circuit control system for multiple power control topologies,

FIG. 2 illustrates the IC control system coupled to a Buck (step-down) power converter circuit.

FIG. 3 illustrates the signal flow within the IC control system for the configuration of FIG. 2.

FIG. 4 illustrates the IC control system coupled to a Boost (step-up) power converter circuit.

FIG. 5 illustrates the signal flow within the IC control system for the configuration of FIG. 4.

FIG. 6 illustrates the IC control system coupled to a flyback power converter circuit

FIG. 7 illustrates the signal flow within the IC control system for the configuration of FIG. 6.

FIG. 8 illustrates the IC control system coupled to a linear power converter circuit.

FIG. 9 illustrates the signal flow within the IC control system for the configuration of FIG. 8.

FIG. 10 is a flow chart of a method of using the IC control system.

### DETAILED DESCRIPTION

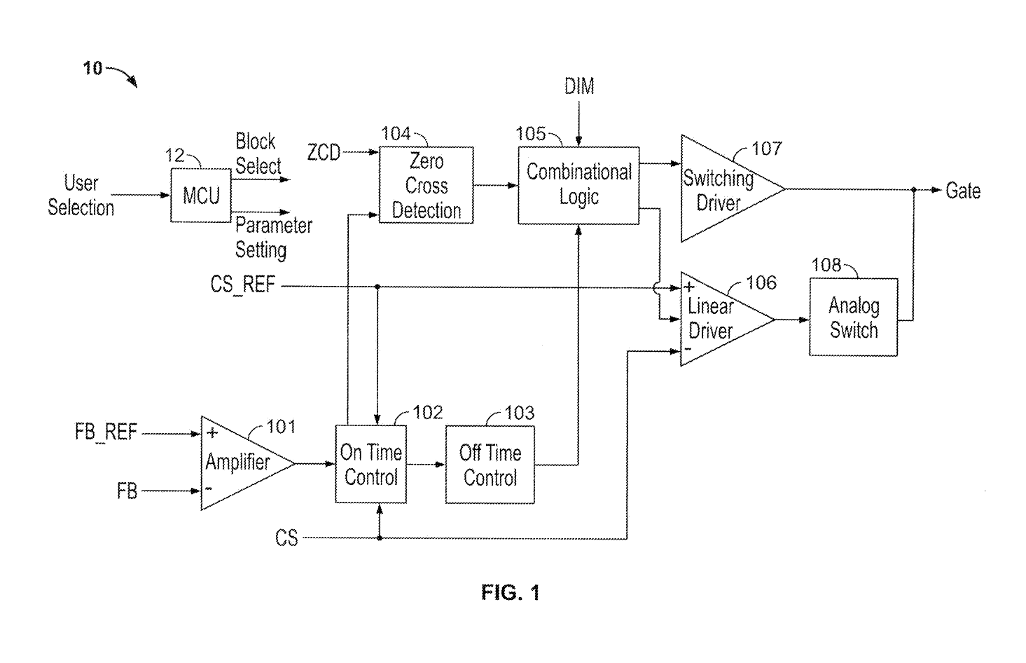

As shown in FIG. 1 a user-programmable integrated circuit (IC) control system 10 includes various functional blocks implemented in hardware (i.e., circuitry), each of which of can be enabled or disabled by a control unit, such as a reprogrammable logic device or a microcontroller unit (MCU) 12, based on a user input signal indicative of a particular power control topology. The user input signal can be a multi-hit signal that indicates to reprogrammable logic device or a microcontroller unit (MCU) 12 which one of several operating modes or power control topologies the user wishes to implement. In response, reprogrammable logic device or microcontroller unit (MCU) 12 provides output signals to enable (or disable) selected ones of the functional blocks. Decoding of the use input signal indicative of a particular power control topology can be performed by logic that is hardwired in MCU 12. In sonic implementations, MCU 12 sends the user input signal indicative of a particular power control topology. A separate dedicated decoding logic can decode this signal to enable or disable the various functional blocks.

IC control system 10 can be implemented, for example, in a single semiconductor chip. In the example of FIG. 1, the functional blocks include an amplifier I 01, an ON time control circuit 102, an OFF time control circuit 103, a zero cross detection circuit 104, combinational logic 105, a linear driver 106, a switching driver 107, and an analog switch 108. Different combinations of the functional blocks 101 through 108 are enabled (or disabled) depending on the user-selected power control topology with which IC control system 10 is to be used.

Depending on the particular power control topology, IC control system 10 can receive one or more input signals from external application-specific circuitry. example, ON time control circuit 102 and the negative (−) input of linear driver 106 can receive a current sensing signal (CS) by way of a first input pin. Likewise, the negative (−) input of amplifier 101 can receive a feedback signal (FB) by way of is second input pin, and zero cross detection circuit 104 can receive a zero cross detection signal (ZCD) by way of a third input pin, Depending on the particular external application-specific circuitry, fewer than all the input signals may be used in any given application.

In addition to generating signals to enable/disable the selected functional blocks within IC control system 10, reprogrammable logic device or MCU 12 also is operable to generate parameter setting signals. In the example of FIG. 1, the parameter settings include a feedback reference signal (FB_REF) that can be provided to the positive (+) input of amplifier 101 and a current sensing reference signal (CS_REF) that can be provided to ON time control circuit 102 and/or to the positive (+) input of linear driver 106. The particular parameter settings generated by reprogrammable logic device or microcontroller unit (MCU) 12 depend on the user-selected mode of operation as indicated by the user input signal. In addition to parameter setting signals, reprogrammable logic device or MCU 12 can generate dimming signal DIM for global ON and OFF for all the supported power topologies.

As shown in FIG, 1, an output from amplifier 101 can be coupled to ON time control circuit 102. A first output from ON time control circuit 102 can be coupled to OFF time control circuit 103, and an output from OFF time control circuit 103 can be coupled to combinational logic 105. Likewise, a second output from ON time control circuit 102 can be coupled to zero cross detection circuit 104, and an output from zero cross detection circuit 104 can be coupled to combinational logic 105. DIM signal combinational logic 105 facilitates performance of low-frequency ON/OFF control of a GATE output. An output from combinational logic 105 can be coupled to switching driver 107. An output (GATE) from IC control system 10 can be provided either from the output of switching driver 107 or from the output of linear driver 106 through an analog switch 108. The output signal (GATE) can be used, for example, to control a switching transistor in the external application-specific circuitry.

The following paragraphs describe various examples of how IC control system 10 can be used with a wide range of power control topologies. The topologies described include a Buck power converter (step-down voltage regulator) topology, a Boost power converter (step-up voltage regulator) topology, a flyback power converter topology, and a lineal power converter topology. Thus, the same IC control system 10 can be used for non-isolated topologies (e.g., Buck and Boost) as well as isolated topologies (e.g., flyback). Some implementations of IC control system 10 may be configurable for use with fewer than all the foregoing power converter topologies. Likewise, some implementations may be configurable for use with additional or different types of power converter topologies as well.

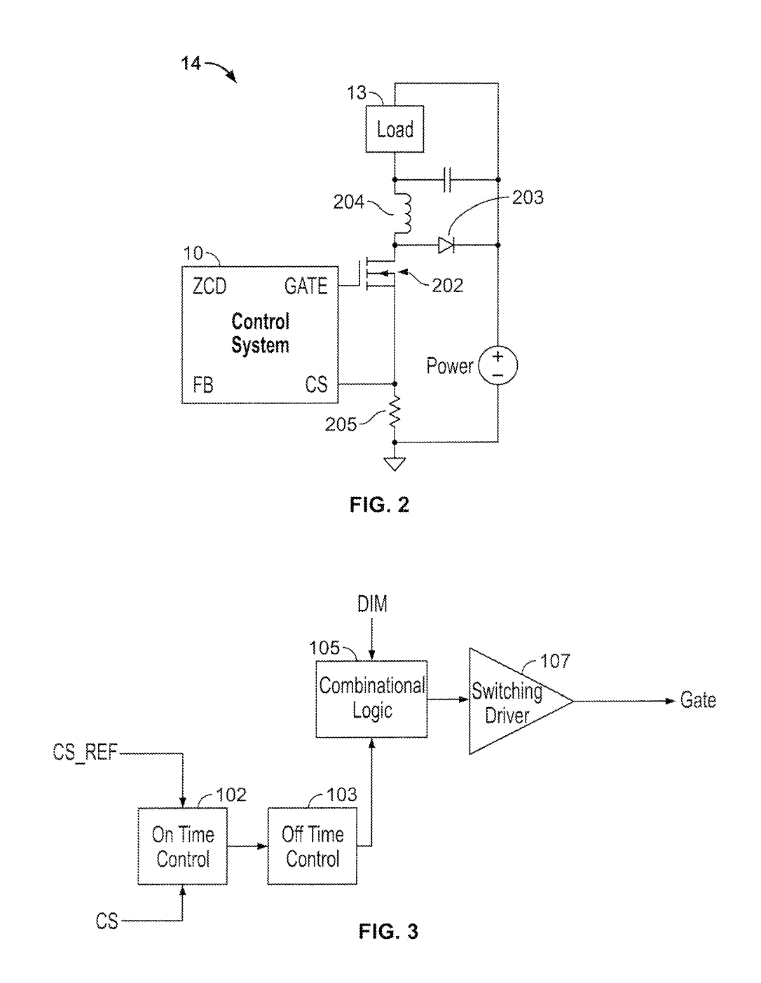

FIG. 2 illustrates IC control system 10 coupled to a Buck (step-down) power converter circuit 14. The switching components of circuit 14 include switching transistor 202, diode 203 and inductor 204. Resistor 205 provides the feedback input to IC control system 10 via input pin CS. IC control system 10 provides a control signal to switching transistor 202 via output pin GATE. Inductor 204 is connected between switching transistor 202 and a load 13. Load 13 can be, for example, a single LED, a string of LEDs or multiple strings of LEDs in parallel or in series. In this topology, input pins FB and ZCD of IC control system 10 are not used.

When IC control system 10 is configured for use with power converter circuit 14 as in FIG. 2, reprogrammable logic device or MCU 12 enables the following functional blocks within the IC control system: ON time control circuit 102, OFF time control circuit 103, combinational logic 105, and switching, driver 107. Thus, the foregoing functional blocks are active. The other functional blocks (i.e., amplifier 101, zero cross detection circuit 104, linear driver 106 and analog switch 108) remain disabled and are not active. FIG. 3 illustrates the signal flow within IC control system 10 for the configuration of FIG. 2.

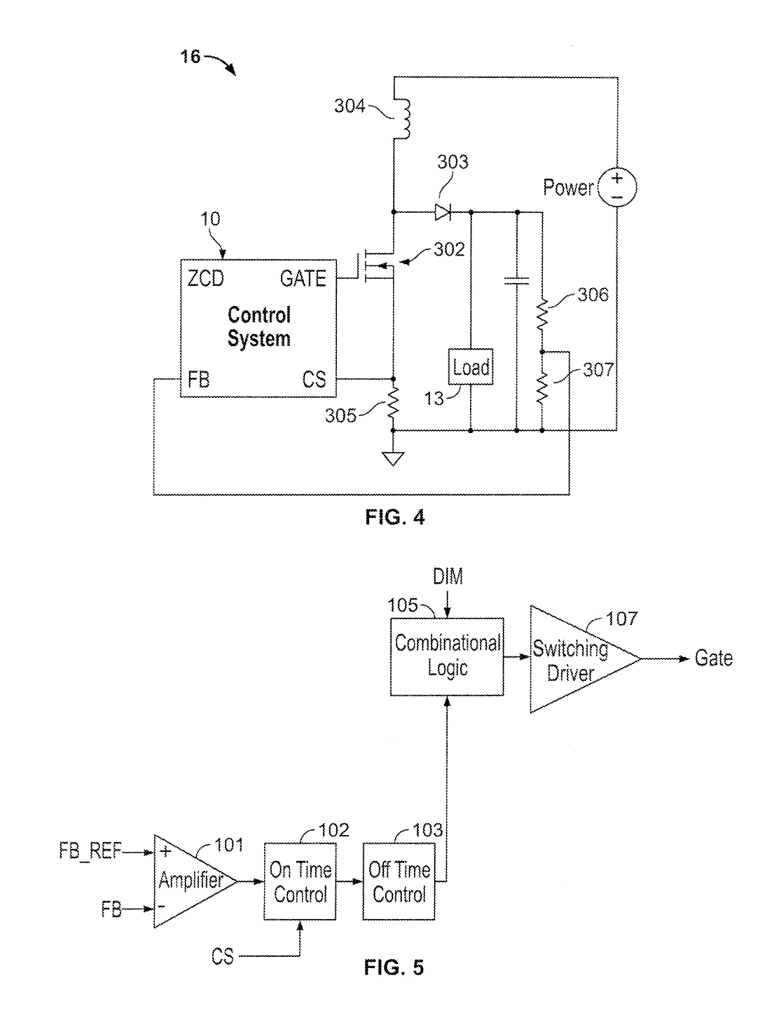

FIG. 4 illustrates IC control system 10 coupled to a Boost (stop-up) power converter circuit 16. The switching components of circuit 16 include switching transistor 302, diode 303 and inductor 304. Resistor 305 provides a first feedback input to IC control system 10 via input pin CS, and resistors 306, 307 provide a second feedback input to IC control system 10 via input pin FB. IC control system 10 provides a control signal to switching transistor 302 via output pin GATE. Load 13, which can be, for example, a single LED, a string of LEDs or multiple strings of LEDs in parallel or in series, is connected between the cathode of diode 303 and ground. In this topology, input pin ZCD of IC control system 10 is not used.

When IC control system 10 is configured for use with power converter circuit 16 as in FIG. 4, reprogrammable logic device or MCU 12 enables the following functional blocks within the IC control system: amplifier 101, ON time control circuit 102, OFF time control circuit 103, combinational logic 105, and switching driver 107. Thus, the foregoing functional blocks are active. The other functional blocks (i.e., zero cross detection circuit 104, linear driver 106 and analog switch 108) remain disabled and are not active. FIG. 5 illustrates the signal flow within IC control system 10 for the configuration of FIG. 4.

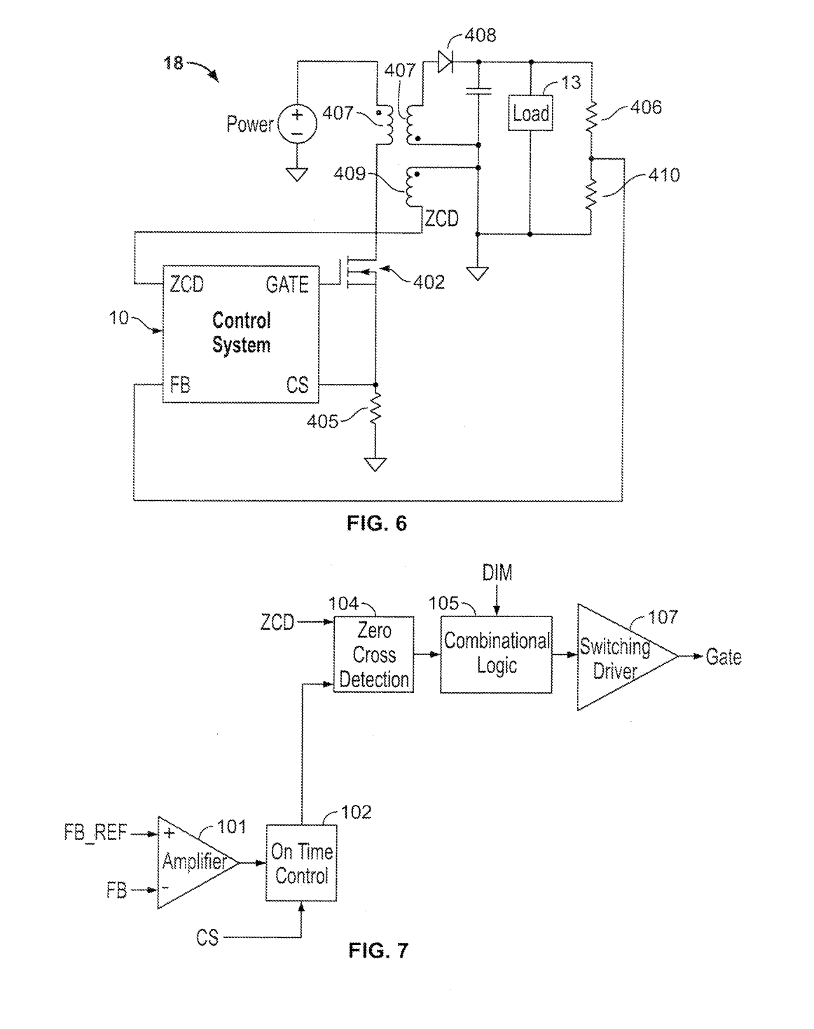

FIG. 6 illustrates IC control system 10 coupled to a flyback power converter circuit 18. This topology can be used, for example, for isolation or power factor correction (PFC) implementations. Switching components for the primary-side power conversion include switching transistor 402 and transformer 407. Switching components for the secondary-side power conversion include transformer 407 and diode 408. Resistor 405 provides a first feedback input to IC control system 10 via input pin CS. Resistors 406, 410 provide a second feedback input to IC control system 10 via input pin FB. Auxiliary flyback winding 409 provides a third feedback input to IC control system is input pin ZCD. IC control system 10 provides a control signal to switching transistor 402 via output pin GATE. Load 13, which can be, for example, a single LED, a string of LEDs or multiple strings of LEDs in parallel or in series, is connected between the cathode of diode 408 and ground. In this topology, all three input pins (CS, FB and ZCD) of IC control system 10 are used.

When IC control system 10 is configured for use with power converter circuit 18 as in FIG. 6, reprogrammable logic device or MCV 12 enables the following; functional blocks within the IC control system: amplifier 101, ON time control circuit 102, zero cross detection circuit 104, combinational logic 105 and switching driver 107. Thus, the foregoing functional blocks are active. The other functional blocks (i.e., OFF time control circuit 103, linear driver 106 and analog switch 108) remain disabled and are not active. FIG. 7 illustrates the signal flow within IC control system 10 for the configuration of FIG. 6.

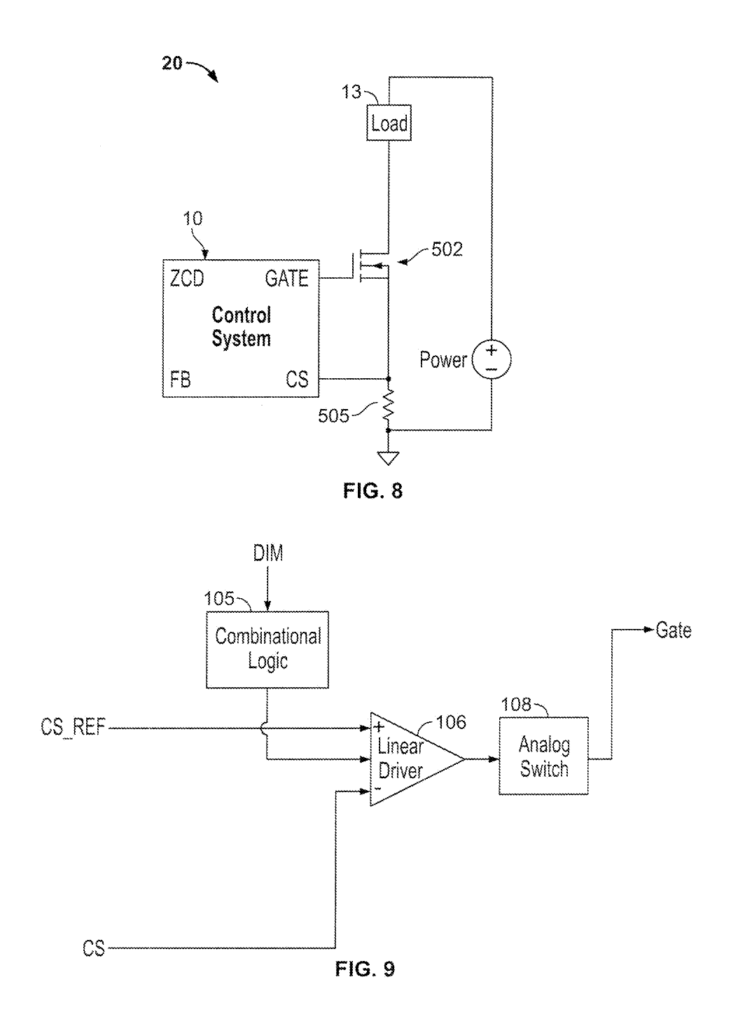

FIG. 8 illustrates IC control system 10 coupled to a linear power converter circuit 20. The switching components of circuit 20 include linear pass transistor 502. Resistor 505 provides a feedback input to IC control system 10 via input pin CS. IC control system 10 provides a control signal to linear pass transistor 502 via output pin GATE. Load 13, which can be, for example, a single LED, a string of LEDs or multiple strings of LEDs in parallel or in series, is connected the drain of linear pass transistor 502 and the positive (+) pin of the power source. In this topology, input pins FB and ZCD of IC control system 10 are not used.

When IC control system 10 is configured for use with power converter circuit 20 as in FIG. 8, reprogrammable logic device or MCU 12 enables the following functional blocks within the IC control system: current sense input CS, combinational logic 105, linear driver 106 and analog switch 108. Thus, the foregoing functional blocks are active. The other functional blocks (i.e., amplifier 101, ON time control circuit 102, OFF time control circuit 103, zero cross detection circuit 104, and switching driver 107) remain disabled and are not active. FIG. 9 illustrates the signal flow within IC control system 10 for the configuration of FIG. 8.

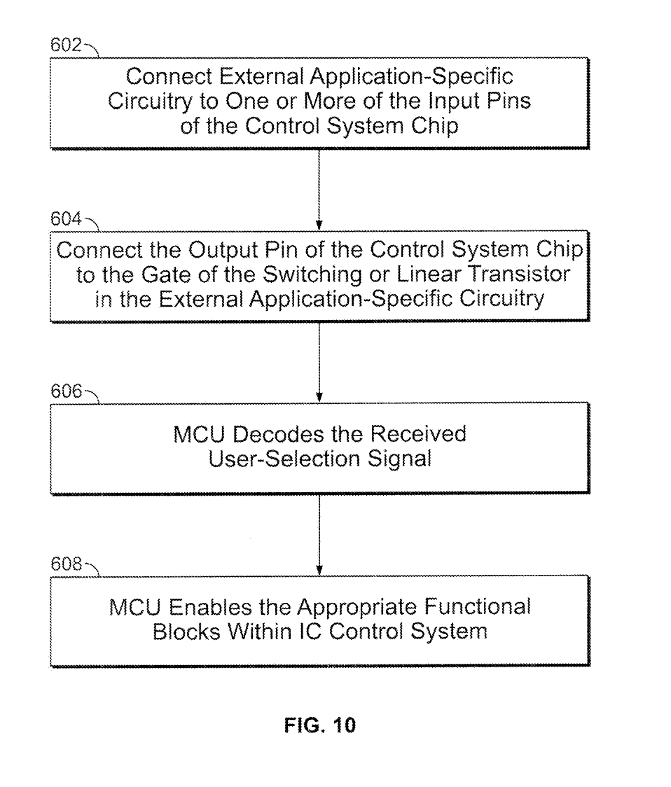

As is evident from the foregoing examples, the same IC control system 10 can be used for any of multiple power control topologies. As indicated by FIG. 10, depending on the topology chosen by the user (e.g., a design engineer), the external application-specific circuitry is connected to one or more of the input pins (CS, FB, ZCD) of the control system chip (block 602), and the output pin (GATE) of the control system chip is connected to the gate of the switching or linear transistor (e.g., 202, 302, 402, or 502) in the external application-specific circuitry (block 604). Based on the received signal indicative of the user-selected topology, reprogrammable logic device, dedicated decoder or MCU 12 decodes the received signal (block 606) and enables the appropriate functional blocks within IC control system 10 (block 608) to facilitate implementation of the particular topology. As described above, only those functional blocks that are needed for the particular power conversion topology are enabled.

Although the foregoing example of IC control system 10 includes particular functional blocks (i.e. circuitry and logic blocks 101 through 108), other implementations may include additional or different functional blocks to allow the IC control system to be used with other power control topologies.

Other implementations are within the scope of the claims.

What is claimed is:

1. An integrated circuit operable for implementing any of multiple switched mode or linear power control topologies, the integrated circuit comprising:
a control unit; and
a plurality of functional blocks each of which includes circuitry,
wherein the control unit is operable selectively to enable particular ones of the functional blocks in response to an input signal indicative of a particular one of the switched mode or linear mode power control topologies.

2. The integrated circuit of claim 1 including a plurality of input/output pins for connection to an external application-specific power control circuit.

3. The integrated circuit of claim 2 including an output pin fur connection to a gate of a semiconductor switching element or linear control element in the external application-specific power control circuit.

4. The integrated circuit of claim 1 wherein the functional blocks collectively include circuitry to implement at least two of the following switched mode or linear mode power control topologies: a Buck power conversion topology, a Boost power conversion topology, flyback power conversion topology and a linear power conversion topology.

5. The integrated circuit of claim 1 wherein the functional blocks collectively include circuitry to implement at least three of the following switched mode or linear mode power control topologies: a Buck power conversion topology, a Boost power conversion topology, a flyback power conversion topology and a linear power conversion topology.

6. The integrated circuit of claim 1 wherein the functional blocks collectively include circuitry to implement at least the following switched mode power or linear mode control topologies: a Buck power conversion topology, a Boost power conversion topology, a flyback power conversion topology and a linear power conversion topology.

7. The integrated circuit of claim 1 wherein the control unit is operable to generate one or more parameter settings for one or more of the functional blocks depending on the specific one of the power control topologies indicated by the input signal.

8. The integrated circuit of claim 1 wherein the functional blocks include:
an amplifier;
ON time control circuitry;
OFF time control circuitry;
zero cross detection circuitry;
combinational logic;
a switching driver;
a linear driver; and
an analog switch.

9. The integrated circuit of claim 8 wherein:
a first output from the ON time control circuitry is coupled to the OFF time control circuitry,
an output from the OFF time control circuitry is coupled to the Combinational a second output from the ON time control circuitry is coupled to the zero cross detection circuitry,
an output from the zero cross detection circuitry is coupled to the combinational logic,
first output from the combinational logic is coupled to the switching driver,
a second output form the combinational logic is coupled to the linear driver, and
an output from either the switching driver or the analog switch is connected to an output pin of the integrated circuit.

10. The integrated circuit of claim 9 including a first input pin coupled to the ON time control circuitry, a second input pin coupled to the amplifier, and a third input pin coupled to the zero cross detection circuitry.

11. The integrated circuit of claim 10 wherein the control unit is operable to provide a first parameter setting to the linear driver and a second parameter setting to the zero cross detection circuitry.

12. A method of implementing a switched mode or linear mode power control topology, the method comprising:
connecting external application-specific circuitry to one or more input/output pins of an integrated circuit that is operable for implementing any of multiple switched mode or linear mode power control topologies; and
providing a user-selection signal as an input to the integrated circuit, wherein the user-selection signal is indicative of a particular one of the switched mode or linear mode power control topologies and causes a control unit in the integrated circuit selectively to enable a particular group of functional blocks in the integrated circuit, each of the functional blocks comprising circuitry.

13. The method of claim 12 including connecting an output pin of the integrated circuit to a gate of a switching transistor in the external application-specific circuitry.

14. A method of implementing a particular switched mode or linear mode power control topology using an integrated circuit that is operable for use with any of multiple switched mode or linear mode power control topologies, the method comprising:
receiving a user-selection signal as an input to the integrated circuit, wherein the user-selection signal is indicative of a particular one of the switched mode or linear mode power control topologies; and
selectively enabling, in response to the user-selection signal, a particular group of functional blocks in the integrated circuit, each of the functional blocks comprising circuitry.

15. The method of claim 14 including generating one or more parameter settings for one or more of the functional blocks depending on a specific one of the power control topologies indicated by the user-selection signal.

16. The method of claim 14 wherein only the functional blocks needed for the particular power conversion topology are enabled in response to the user-selection signal.

17. The method of claim 14 wherein the functional blocks that are selectively enabled are a sub-group from among the following functional blocks in the integrated circuit:
an amplifier;
ON time control circuitry;
OFF time control circuitry:
:zero cross detection circuitry;
combinational logic;
a switching driver;
a linear driver; and
an analog switch.

18. The method of claim 17 including providing from a control unit in the integrated circuit at least one of a first parameter setting to the linear driver or a second parameter setting to the zero cross detection circuitry.
